(19) United States
(12) Patent Application Publication
(10) Pub. No.: US 2011/0004344 A1
(43) Pub. Date: Jan. 6, 2011

(54) MIXER, AND DEVICE AND METHOD FOR MONITORING OR CONTROLLING SAID MIXER

(75) Inventors: Jean-Francois Pinton, Lyon (FR); Pascal Metz, Lyon (FR); Yoann Gasteuil, Lyon (FR); Woodrow Lee Shew, Washington, DC (US)

Correspondence Address: OCCHIUTI ROHLICEK & TSAO, LLP, 10 FAWCETT STREET, CAMBRIDGE, MA, 02138, US

(73) Assignees: ECOLE NORMALE SUPERIEURE DE LYON, Lyon (FR); CENTRE NATIONAL DE LA RECHERCHE SCIENTIFIQUE, Paris (FR)

(21) Appl. No.: 12/865,775

(22) PCT Filed: Jan. 27, 2009
(86) PCT No.: PCT/EP2009/050880

§ 371 Date: Aug. 2, 2010

(30) Foreign Application Priority Data
Feb. 8, 2008 (FR) 08/00682

(51) Int. Cl. G05D 11/02

(52) U.S. Cl. 700/265

(57) ABSTRACT

The invention relates to a mixer that includes:—at least one instrumented particle (24) included in a mixture of products, each instrumented particle being: a. capable of moving freely and independently within the mixture under the action of products stirred by an agitator (14), and b. equipped with at least one sensor capable of measuring a characteristic of the mixture;—and a processing unit (30) capable of monitoring or controlling the mixer on the basis of the measures made by each instrumented particle.

The invention pertains to a mixer as well as to a device and a method for monitoring or controlling this mixer. The present filing party knows a mixer comprising:
a receptacle in which fluid or granular products to be mixed are received in order to form a mixture, these products being distinguished from one another, before mixing, by at least one measurable physical variable,
an agitator capable of stirring the products present in the receptacle, and
a device for monitoring or controlling the mixer as a function of at least one measurable characteristic of the mixture.

The monitoring or control device is a device used to ascertain that the mixing takes place in compliance with a preset plan and/or for controlling different pieces of equipment of the mixer such as the agitator so that the mixing takes place according to this preset plan.

For example, if the measurable characteristic used represents the homogeneity of the mixture then the device is used to stop the mixer when the mix is homogenous. The measurable characteristic used may also represent the evolution of a process related to the mixing such as a chemical reaction. In the latter case, the device is used to monitor the efficient running of the process and to act on the mixer if the process does not run as planned.

In prior art mixers, the monitoring or precise control of the progress of the mixing is rendered very difficult by the fact that the value of the characteristic used to monitor or control the mixer is not uniform throughout the volume of the mix.

To illustrate this problem, an example is taken here of a mixture between a blue paint and a yellow paint made in order to obtain a uniformly green mixture.

There are known ways of placing a color sensor on one side of the receptacle in which this mixing is taking place. It might be expected that it would be easy to monitor or control this mixer from the measurements made by this sensor. For example, it might be planned to stop the mixing automatically when the color measured by this sensor is uniformly green. In practice, it is not possible to proceed in this way. Indeed, even if locally, in the vicinity of the sensor, the measured color is uniformly green, residual pockets of blue or yellow paint often remain within the mixture itself. The monitoring or control of this mixture with such a device is therefore inefficient.

The invention seeks to overcome these problems by proposing a mixer in which the monitoring or control of the mixing is more efficient.

An object of the invention therefore is a mixer in which the monitoring or control device comprises:
at least one instrumented particle incorporated into the mixture, each instrumented particle being:
   a. capable of moving freely and autonomously within this mixture under the effect of the products stirred by the agitator and
   b. equipped with at least one sensor capable of measuring the characteristic of the mixture,
a processing unit capable of monitoring or controlling the mixer as a function of the measurements of the characteristic made by each instrumented particle.

In the above mixture, since the instrumented particles are free to move in the mixture, they are capable of measuring the characteristic at numerous points of this mixture including beneath the visible surface of the mixture. The number of instrumented particles is smaller than the number of points at which a measurement can be made. This limits the number of sensors used as compared with a situation where it might be sought to obtain the same measurements by using sensors fixed to the walls of the receptacle.

Furthermore, the instrumented particles move in the mixture under the effect of turbulent flows created by the agitator. It is therefore not necessary to provide for specific propulsion means for these particles.

The equipped mixer of the monitoring or control device here above therefore makes it possible simply to monitor or control the running of the mixer more efficiently.

The embodiments of this mixer may comprise the following characteristic:
the agitator is a mechanical agitator fixedly joined to the receptacle and capable of mechanically shaking the products received in the receptacle in order to stir them with one another.

An object of the invention also is a device for monitoring or controlling a mixer capable of being implemented in the above mixer.

The embodiments of this monitoring or control device may comprise the following characteristics:
the density of each instrumented particle is equal to the density of the mixture to within plus or minus 10%;
the processing unit is capable of indicating the end of the mixing when the instantaneous measurements of the characteristic are equal, during a predetermined time slot, to the mean value of the measurements made to within + or −Δg, Δg being a predetermined threshold;
the device comprises several instrumented particles, each equipped with a sensor capable of measuring said characteristic of the mixture;
each instrumented particle comprises an emitter for transmitting the measurements made of the characteristic through a wireless link, and the processing unit comprises a receiver capable of receiving the measurements transmitted by each instrumented particle;
the device comprises a locator capable of reading the position of each instrumented particle in a referential system fixedly linked to a receptacle in which the mixing is done, and a processing unit is capable of monitoring or controlling the mixer according to the measurements made by each instrumented particle and the positions read;
the characteristic measured by the sensor of each instrumented particle represents the physical variable distinguishing the mixed products from one another.

These embodiments of the monitoring or control device furthermore have the following advantages:
when the instrumented particles substantially have the same density as that of the mixture, they uniformly scan the entire volume of the mixture, thus preventing the introduction of a bias into the measurements in taking account for example preferably, of what happens towards the bottom of the receptacle or on the contrary towards the surface of the receptacle,
the indication of the end of the mixing on the basis of the measurements made by the instrumented particles stops the mixer just when the mixture is considered to be homogenous in the receptacle with respect to the measured characteristic,
the simultaneous use of several instrumental particles in the same mixture makes the determining of homogeneity in the mixture for example faster and more precise,
transmitting the measurements via wireless link to the processing unit reduces the size of the particles and therefore, ultimately, improves the monitoring or control of the running of the mixing,
locating the instrumented particles within the mixture improves the monitoring or control of the mixer in taking account for example of the places where the inhomogeneities are located within the mixture.

Finally, an object of the invention is also a method for monitoring or controlling a mixer of fluid or granular products that are distinguished from one another, before mixing, by at least one measurable physical variable characterized in that the method comprises:
the shifting in the mixture of at least one instrumented particle under the effect of the products stirred by an agitator,
the measurement by each instrumented particle of at least one measurable characteristic of the mixture, and
the monitoring or controlling of the mixer as a function of the measurements made by each instrumented particle.

The invention will be understood more clearly from the following description given purely by way of a non-restrictive example and made with reference to the drawings of which:

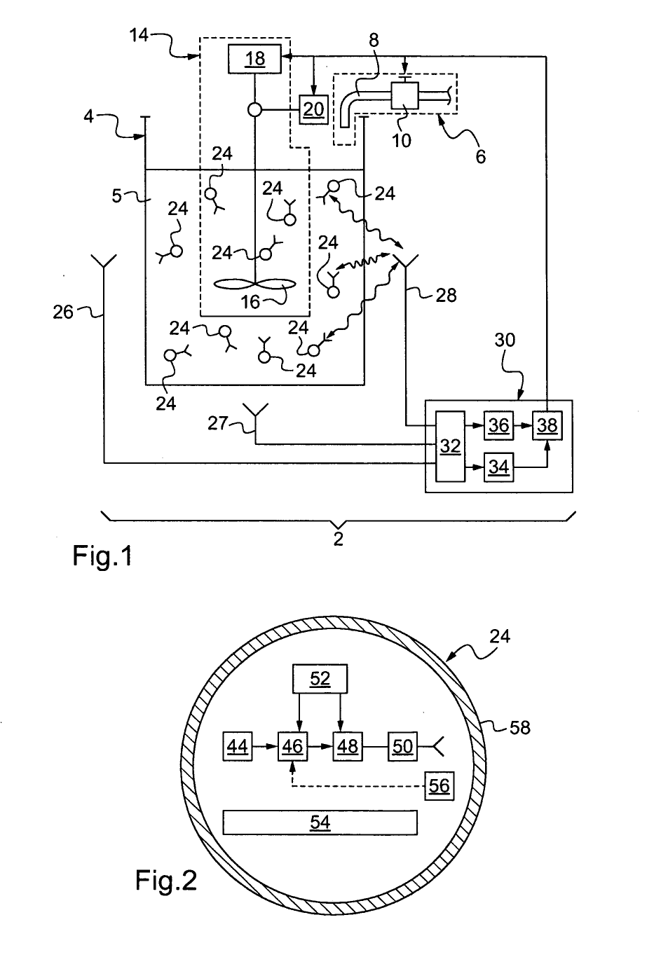

FIG. 1 is a schematic illustration of the architecture of a mixer equipped with a monitoring or control device,

FIG. 2 is a schematic illustration of an instrumented particle of the monitoring or control device of FIG. 1,

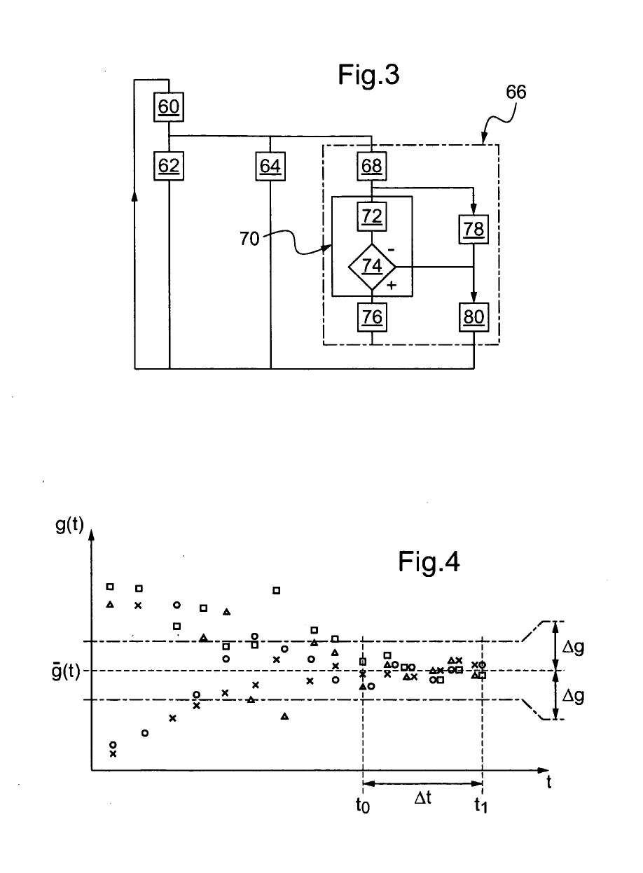

FIG. 3 is a flowchart of a method for monitoring and controlling the mixer of FIG. 1,

FIG. 4 is a graph schematically illustrating the different measurements read by instrumented particles of the monitoring and control device of FIG. 1,

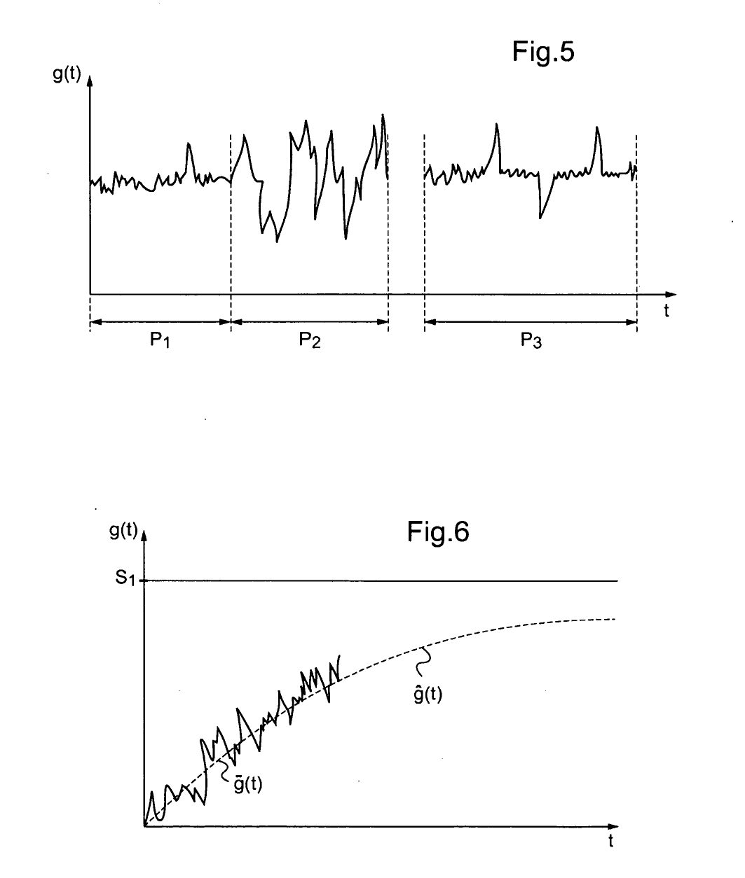

FIGS. 5 and 6 are graphs representing the evolution in time of the measurements made by two other embodiments of the instrumented particle of FIG. 2.

In these figures, the same references are used to designate the same elements. Here below in the description, the characteristics and functions well known to those skilled in the art shall not be described in detail.

FIG. 1 shows a mixer 2. This mixer 2 has a receptacle 4 containing a mixture 5 of different products. The products to be mixed are poured into the receptacle 4 by a controllable dosing unit 6.

The products introduced into the receptacle 4 are distinguished from one another, before mixing, by at least one measurable physical variable. Thus, just before the products are introduced into the receptacle, the mixture 5 is non-homogenous.

For example, the aim of the mixer is to make the mixture 5 homogenous with respect to the spatial distribution of the values of one locally measurable characteristic of this mixture. More specifically, a mixture is considered here to be inhomogenous if, in the mixture, there is at least one first pocket and one second pockets of products in which the measured characteristic has respectively a first and a second different value, the difference between these first and second values being greater than a predetermined threshold. The minimum size of the pockets taken into account and the predetermined threshold is for example fixed preliminarily by the user according to the products to be mixed. Conversely, the mixture 5 is considered to be homogenous if it is not inhomogenous.

For example, here, the characteristic of the mixture that can be locally measured is the physical variable which, before mixing, makes it possible to distinguish the mixed products.

By way of an illustration only, the embodiment of FIG. 1 is described in the particular case in which the mixed products are liquid paints, yellow and blue respectively. In this context, the aim of the mixer is to obtain a homogenous mixture that is uniformly green.

The dosing unit 6 is capable of introducing proportioned quantities of each of the products to be mixed into the receptacle 4. For example, the dosing unit 6 is formed by pipes, each fitted out with a controllable dosing pump. To simplify FIG. 1, only the pipe 8 and a dosing pump 10 have been shown. Each pipe opens into the receptacle 4. Here, the dosing unit 6 introduces dosed volumes of paints of different colors into the receptacle 4.

The mixer 2 has a controllable agitator 14 to stir the products received in the receptacle 4. For example, to this end, the agitator 14 has a fan 16 driven rotationally by a motor 18.

Here, the position of the agitator 14 relatively to the receptacle 4 can be adjusted by means of a mechanism 20 for shifting the agitator 14 relatively to the walls of the receptacle 4. For example, the mechanism 20 tilts the rotational axis of the fan 16 in different directions.

The mixer 2 is equipped with a monitoring and control device. This device comprises:
several instrumented particles 24 incorporated into the mixture 5,
three antennas 26 to 28 positioned around the receptacle 4, and
a processing unit 30 capable of monitoring and controlling the progress of the mixing.

Each instrumented particle 24 is capable of measuring the physical variable used to differentiate the mixed products in the receptacle 4. For example here, these particles 24 are each equipped with a color sensor for differentiating the two paints of different colors. These particles 24 are also equipped with an emitter for the real-time, simultaneous sending of the measurements made by their respective sensors to the antennas 26 to 28. The particles 24 are described in greater detail with reference to FIG. 2.

The antennas 26 to 28 are positioned outside the receptacle 24 so as to receive the measurements made by the particles 24. Here, the three antennas 26 to 28 are positioned relatively to one another so as to enable a location of each instrumented particle by triangulation.

The processing unit 30 has a receiver 32 connected to each of the antennas 26 to 28 so as to receive the measurements sent by the particles 24.

The unit 30 also has:
a locator 34 capable of determining the location of each particle 24 within the receptacle 4 by triangulation according to the power of the signals received by the antennas 26 to 28.
a module 26 for monitoring the mixer itself, for example detecting an inhomogeneity in the mixture 5 from the measurements transmitted by the particles 24, and
a module 38 for controlling the mixer 4 to act on the running of the mixture. For example here, the module 28 is capable of controlling the following pieces of equipment of the mixer 2:
the motor 18 to adjust the rotational speed of the fan 16,
the mechanism 20 to orient the fan 16 in a predetermined direction, and
the dosing unit 6 to introduce, if necessary, new quantities of products into the mixture 5.

FIG. 2 gives a more detailed view of an instrumented particle 24. Here, to simplify the description, it is assumed that all the instrumented particles 24 are identical.

Each particle 24 comprises:
a sensor 44 of the physical variable used to differentiate the products to be mixed before they are introduced into the receptacle 4 and mixed,
an analog-digital converter 46 capable of converting the signals delivered by the sensor 44 into digital signals,
a multiplexer 48 capable of multiplexing the digital signals from several sensors when the particle 24 is equipped with several sensors, and
an emitter 50 capable of sending the multiplexed digital signals delivered by the multiplexer 48 to the antennas 26 to 28.

The particle 24 also has a microcontroller 52 capable of controlling the different elements of the particle 24. Finally, the particle 24 includes a battery 54 for supplying all the equipment of the particle.

FIG. 2 also shows a second sensor 56 in dashes. The second sensor 56 can be identical to the sensor 44, i.e. capable of measuring the same physical variable as the sensor 44 or, on the contrary, capable of measuring a physical variable other than the one measured by the sensor 44. Should the sensors 44 and 56 measure the same physical variable, they are positioned at different places on the rim of the particle 24 and preferably diametrically opposite to each other.

The sensor 56 like the sensor 44 is connected to the converter 46.

In the embodiment of FIG. 1, the particle 24 has only the sensor 44. The sensor 44 is a color sensor capable of distinguishing between the two mixed paints by their respective colors.

The particle 24 also has a protective shell 58 capable of protecting the different electronic apparatuses it contains from the external environment within which it is designed to be incorporated. The sphere 58 has a diameter D. The diameter D is small enough for the cumulated volume of all the particles 24 to remain small as compared with the volume of the mixture. For example the cumulated volume of the particles 24 is smaller than 10% of the volume of the mixture. Thus, the presence of the particles does not hamper the mixture. In this case, the diameter D is smaller than 2 cm and preferably smaller than 1 cm.

The weight of the particle 24 is sufficient for it to be capable of traversing the different pockets of products during the mixing.

Here, the diameter D of the particle 24 is chosen so that the density of this particle is substantially equal to the density of the mixture 5. Here, the term “substantially equal” indicates the fact that the density of the particle 24 is equal to the density of the mixture 5 to within + or −10%.

The density of the particle 24 is equal to the volume of this particle divided by its weight. The density of the mixture 5 is equal to the volume of this mixture divided by its weight. If the mixture is made at constant weight and volume, the volume of the mixture can be determined in principle by the ratio of the volumes of the products to be mixed to the weight of the products to be mixed.

In this embodiment, the diameter D is given by the following relationship:

m=ρ_{F}πD³/6

where:
m is the mass of the particle 24,
ρ_{F} is the density of the mixture 5,
D is the diameter to be determined of the particle 24.

When the density of the particle 24 is substantially equal to that of the mixture 5, then the particles 24 uniformly scan the entire volume of the mixture 5, thus improving the reliability of the monitoring and control device of the mixer 2.

The working of the mixer 2 shall now be described with reference to the method of FIG. 3 in the particular case of the mixing of two paints colored yellow and blue.

Initially, at a step 60, the particles 24 are incorporated into the mixture 5. For example, the particles 24 are introduced at the same time as the products to be mixed into the receptacle 4.

Then, at a step 62, the agitator 14 is commanded to stir the products to be mixed within the receptacle 4. Here, the motor 18 rotationally drives the fan 16 which itself stirs the different products present in the receptacle 4. This stirring of the products also causes the shifting of the particles 24 within the receptacle 4 under the effect of turbulent flows created in the mixture 5 by the fan 16.

Here, the particles 24 are free to move within the mixture 5 and are not attached by any element to the walls of the receptacle 4 or to the agitator 14. Furthermore, each particle 24 is autonomous relatively to the other particles. Thus, the particles 24 uniformly scan the entire volume of the mixture 5.

In parallel with the step 62, at a step 64, the sensor 44 of each particle 24 makes an instantaneous measurement gᵢ(t) of the physical variable that differentiates the mixed products, i.e. in this case their color. The index i identifies the particle 24 that has made the measurement.

At the step 64, each measurement gᵢ(t) is instantaneously sent to the receiver 32 by means of a wireless link set up between the emitter 50 of this particle and the antennas 26 to 28.

In parallel with the steps 62 and 64, the unit 30 performs a phase 66 of monitoring and control of the mixer 2. At the beginning of this phase 66, at a step 68, the receiver 32 receives the measurements gᵢ(t) sent by each of the particles 24.

Each particle 24 sends its measurements at its own frequency so as not to scramble the transmissions from the other particles 24 present in the same mixture. Furthermore, each information frame sent on a particle 24 has an identifier of this particle for identifying this particle amongst all the particles present in the mixture 5.

From the measurements gᵢ(t) received at the step 68, at a step 70, the module 36 determines for example whether the mixture is sufficiently homogenous to be capable of stopping the agitator 14. For example, at the beginning of the step 70, during an operation 72, a mean value g̅ t̅ of the different instantaneous measurements gᵢ(t) sent by each particle 24 is computed. Typically, this mean g̅ t̅ is a sliding mean achieved in a predetermined time slot. Then, in an operation 74, the module 36 checks to see whether each instantaneous measurement gᵢ(t) sent by each particle 24 during the time slot Δt is equal to the mean g̅ t̅ plus or minus Δg. Δg is a tolerance margin on the homogeneity of the mixture. Δg is predetermined by the user. For example, in this case Δg is chosen to be less than 10% of the average g t and preferably less than 5% of the average g̅ t̅.

If all the instantaneous measurements gᵢ(t) sent during the time slot Δt is equal to the mean g t plus or minus Δg, then the module 38, at a step 76, commands the stopping of the agitator 14. Indeed, in this case, the mixture 5 is deemed to have become sufficiently homogenous and to no longer need any mixing.

In parallel with the step 70, at a step 78, the locator 34 determines the position of each particle 24 in a referential system fixedly joined to the receptacle 4. For example, the position of each particle 24 is determined by triangulation from the instants of reception of the measurement gᵢ(t) by the antennas 26 to 28 or from the power of the signals received by each of the antennas 26 to 28.

Then, at a step 80, if it has been determined during the operation 74 that the mixture 5 is not yet sufficiently homogenous, the unit 38 controls the different apparatuses of the mixture 2 as a function of the measurements gᵢ(t) sent by the particles 24 and the location of the particles 24 obtained during the step 78. For example, from each measurement gᵢ(t) and the location of the particle that has sent this measurement, the module 38 determines the location of the residual yellow and blue pockets in the receptacle 4. Then, the module 38 commands the mechanism 20 to preferably stir the zones of the mixture 5 in which these residual pockets of the yellow and blue color are located. At the step 80, the module 38 can also command the motor 18 to accelerate or slow down the stirring of the products as a function of the measurements gᵢ(t).

At the step 80, if the average color predicted for the mixture on the basis of the measurements gᵢ(t) sent by each of the particles 24 does not correspond to a target colour fixed by the user, then the module 38 also controls the dosing unit 6 to introduce products during the mixing. For example, if the uniform color predicted for the mixture 5 is too close to yellow, the module 38 commands the adding of blue paint into this mixture.

FIG. 4 represents an example of the evolution in time of the measurements gᵢ(t) made by four particles 24. FIG. 4 shows the measurements of the first, second, third and fourth particles 24 identified respectively by a cross, a circle, a square and a triangle. At the beginning of the mixing, the particles 24 are either in the pockets of yellow paint or in the pockets of blue paint. The mean standard deviation of the distribution of this measurement around the mean g̅ t̅ is therefore important. Then, under the effect of the agitator 14, this mean standard deviation gradually diminishes. The mixture therefore becomes increasingly homogenous and the measurements gᵢ(t) approach the mean g̅ t̅. Starting from the instant t₀, each measurement gᵢ(t) made by any one of the particles 24 is included in a band 2 Δg wide centered about the mean g̅ t̅. The agitator 14 is therefore stopped at the instant t₁ after the time slot Δt has elapsed.

Numerous other embodiments are possible. For example, the sensor 44 can be replaced by any sensor of a locally measurable characteristic of the mixture. This measured characteristic can be different from the physical variable used to differentiate the mixed products before mixing. Such a choice of the characteristic may prove to be opportune if the inhomogeneities of the mixture to be detected appear as a result of reactions that occur between the mixed products, for example. The sensor can also be chosen to measure a representative characteristic of the state of progress of one chemical reaction or other, occurring as and when the mixing is done.

By way of an illustration, the sensor may be a sensor of temperature, pressure, pH, polarography, resistivity, capacitance, spectrophotometry, opactity, turbidity, refractrometry or viscosity. The sensor may also be a biochip, a biosensor or a sensor known as a “lab-on chip”.

Thus, the mixer that has been described and its monitoring and control device can be adapted to many applications. For example, it is not necessary for the mixed products to be mixable liquid products as in the case of the paints. They may also be non-mixable products. The mixed products take liquid, gaseous or granular form. In the case of gases, it must be noted that it is possible to fill the inner space of the particle with a gas that may be lighter than the gases in which the particle is incorporated.

For example, the mixer 2 can be adapted to the monitoring and control of a mixer of granular products such as concrete. In the case of concrete, the granular products to be mixed are sand and gravel. Sand can be distinguished before mixing from gravel by the weight of its grains which is more than ten times smaller than that of a piece of gravel. This difference in weight between a grain of sand and a piece of gravel can be measured by means of accelerometer. Indeed, since the pieces of gravel are heavier than the grains of sand, their inertia is greater. This means that when a piece of gravel strikes an instrumented particle, the amplitude of the deceleration or the acceleration undergone by the instrumented particle is far greater than would be the case if this same particle were to be struck in these same conditions by a grain of sand. Therefore, for this application, the sensor 44 is replaced by an accelerometer. FIG. 5 schematically illustrates the evolution in time of the amplitude a(t) of the acceleration measured by this instrumented particle. When the particle is in a pocket P₁ of the mixture filled only with sand, the impacts of grains of sand on the shell of the particle produce small-amplitude instances of acceleration and deceleration. Conversely, when this particle goes through a zone P₂ of the mixture which is filled only with gravel, the amplitude of the acceleration or deceleration due to impacts of the particle on pieces of gravel is far greater.

Thus, this particle can be used to discriminate between a pocket of sand and a pocket of gravel. For example, to this effect, the module 36 or 38 computes the ratio, in a predetermined time slot Δt, of the mean standard deviation of the measurements a(t) to the mean of these measurements a(t). In the zone P₁, this ratio is small. Conversely, in the zone P₂, this ratio is far greater. Finally, in a zone P₃, where the sand and the gravel is uniformly mixed, this ratio has an intermediate value between the two previous ones. Indeed, in the zone P₃, the variations in amplitude a(t) around the mean are generally small except from time to time when the particle encounters a piece of gravel. This ratio can therefore be used to follow the state of progress of the mixture between the sand and the gravel and, for example, stop the mixer when the ratio reaches a predetermined target value.

The module 38 can be omitted. For example, in this case, as shown in FIG. 6, the instantaneous measurements gᵢ(t) of the instrumented particles are used to predict the evolution of the mean g̅ t̅. In FIG. 6, the predicted evolution of the mean g̅ t̅ is represented by a line of dashes ĝ(t). The predicted evolution ĝ(t) is, for example, used by the module 36 to make sure that the mixture is under proper control and that it will not go beyond a predetermined threshold S₁. Should the predictions indicate that the mixture is deviating from what is expected, the module 36 triggers an alarm. Thus, in this case, the device is used only to monitor the mixing without commanding the mixer to act in the progress of the mixing.

Many other modes of computing the mean g̅ t̅ are possible. For example, the mean g̅ t̅ can be predetermined experimentally by measurements on a homogenous mixture. The mean g̅ t̅ can also be established by using only measurements sent at the instant t.

What has been described in the context of products to be mixed, having substantially the same density, can be applied also to two or more products to be mixed that have different densities. In this case, the density of the instrumented particles in chosen to be substantially equal to the density of the homogenous mixture.

As a variant, the instrumented particles to be incorporated into the mixture do not all have the same density. For example, in the case of a mixture of two products having different densities, there are particles with a density substantially equal to the density of the first product and other particles with a density substantially equal to the density of the second product.

When the turbulence created by the agitator 14 is high enough to make the effect of gravity on the path taken by the particles in the mixture negligible, it is not necessary for the particles to have substantially the same density as the mixed products or the same density as the mixture obtained. The force exerted by gravity on a particle will be considered to be negligible as compared with the force exerted by the turbulence on this particle, if there is at least a ratio of ten between these two forces. For example, the density of the particles in this case ranges from 1/10 to ten times the density of the mixture.

The agitator 14 can be replaced by a mechanical agitator which drives the receptacle 4 rotationally as, for example, in the case of a concrete mixer. The agitator 14 can also create the forces that stir the products to be mixed by other means. For example, the stirring forces may be electromagnetic forces.

The number of instrumented particles incorporated into the mixture can be reduced to one. However preferably, this number is greater than 4 or 10.

Should each particle have several sensors of a same magnitude, the measurements transmitted to the receiver 32 may be differential measurements, i.e. measurements corresponding to the difference between the measurements made by each of the sensors of the particle. A differential measurement is particularly interesting if the sensors are positioned on diametrically opposite sides of the instrumented particle.

One part of the processing operations made here by the processing unit 30 can be done within the very interior of each particle 24. For example, the module 36 can be incorporated into the particles 24. In this case, the particles send no longer the measurements made but only an already pre-processed piece of information such as an alarm.

In this last-named variant, the communication between the particles 24 and the processing unit 30 could then be a two-way communication.

The wave used to locate each particle is not necessarily the same as the one used to transmit the measurements in real-time.

If a less precise location is required, one of the three antennas can be omitted. The location of the particles in the mixture can also be done by means other than triangulation. For example, the particles can be located by means of one or more cameras and an image-processing operation.

Here, the transmission of the measurements to the receiver 32 by the particles implements frequency division multiplexing. As a variant, this frequency-division multiplexing can be replaced by time-division multiplexing. Other technologies such as CDMA (Code Division Multiple Access) can also be used.

1. A mixer comprising:
a receptacle in which fluid or granular products to be mixed are received in order to form a mixture, these products being distinguished from one another, before mixing, by at least one measurable physical variable,
an agitator capable of stirring the products present in the receptacle, and
a device for monitoring or controlling the mixer as a function of at least one measurable characteristic of the mixture,
wherein the device comprises:
at least one instrumented particle incorporated into the mixture, each instrumented particle being:
a. capable of moving freely and autonomously within this mixture under the effect of the products stirred by the agitator and
b. equipped with at least one sensor capable of measuring the characteristic of the mixture,
a processing unit capable of monitoring or controlling the mixer as a function of the measurements of the characteristic made by each instrumented particle.

2. The mixer according to claim 1, wherein the agitator is a mechanical agitator fixedly joined to the receptacle and capable of mechanically shaking the products received in the receptacle in order to stir them with one another.

3. A device for monitoring, or controlling a mixer of fluid or granular products distinguished from one another, before mixing, by at least one measurable physical variable, wherein the device comprises:
at least one instrumented particle, each instrumented particle being:
a. capable of moving freely and autonomously within this mixture under the effect of the products stirred by an agitator and
b. equipped with at least one sensor capable of measuring at least one characteristic of the mixture,
a processing unit capable of monitoring or controlling the mixer as a function of the measurements of the characteristic made by each instrumented particle.

4. The device according to claim 3, wherein the density of each instrumented particle is equal to the density of the mixture to within plus or minus 10%.

5. The device according to claim 3, wherein the processing unit is capable of indicating the end of the mixing When the instantaneous measurements of the characteristic are equal, during a predetermined time slot, to the mean value of the measurements made to within + or −Δg, Δg being a predetermined threshold.

6. The device according to claim 3, wherein the device comprises several instrumented particles, each equipped with a sensor capable of measuring said characteristic of the mixture.

7. The device according to claim 3, wherein each instrumented particle comprises an emitter for transmitting the measurements made of the characteristic through a wireless link, and the processing unit comprises a receiver capable of receiving the measurements transmitted by each instrumented particle.

8. The device according to claim 3, wherein the device comprises a locator capable of reading the position of each instrumented particle in a referential system fixedly linked to a receptacle in which the mixing is done, and the processing unit is capable of monitoring or controlling the mixer according to the measurements made by each instrumented particle and the positions read.

9. The device according to claim 3, wherein the characteristic measured by the sensor of each instrumented particle represents the physical variable distinguishing the mixed products from one another.

10. A method for monitoring or controlling a mixer of fluid or granular products that are distinguished from one another, before mixing, by at least one measurable physical variable wherein this method comprises:
the shifting in the mixture of at least one instrumented particle under the effect of the products stirred by an agitator,
the measurement by each instrumented particle of at least one measurable characteristic of the mixture, and
the monitoring or controlling of the mixer as a function of the measurements made by each instrumented particle.
